(19) United States
(12) Patent Application Publication
(10) Pub. No.: US 2026/0292459 A1
(43) Pub. Date: Sep. 24, 2026

(54) METHODS, ARCHITECTURES, APPARATUSES AND SYSTEMS FOR DEVICE TRANSMISSIONS

(71) Applicant: InterDigital Patent Holdings, Inc., Wilmington, DE (US)

(72) Inventors: Kevin Wanuga, Souderton, PA (US); Erdem Bala, East Meadow, NY (US); Paul Marinier, Brossard (CA); Martino Freda, Laval (CA); Jongwoo Hong, New York, NY (US)

(21) Appl. No.: 19/088,539

(22) Filed: Mar. 24, 2025

(51) Int. Cl. H04W 4/80; H04W 24/08; H04W 72/542

(52) U.S. Cl. CPC H04W 4/80; H04W 24/08; H04W 72/542

(57) ABSTRACT

A wireless transmission/reception unit (WTRU) may monitor a first device to reader (D2R) message via a physical channel transmission based on a first one or more configuration parameters. The WTRU may determine a second one or more configuration parameters based on measurements associated with at least one of the physical channel transmission and the first D2R message. The WTRU may transmit a reader to device (R2D) message including information indicating the second one or more configuration parameters. The second one or more configuration parameters are for use for transmission of a subsequent D2R message via a physical channel. Also provided herein is a method implemented in the WTRU and corresponding device, e.g. an internet of things (IoT) device and method.

### TECHNICAL FIELD

The present disclosure is generally directed to the fields of communications, software and encoding, including, for example, to methods, architectures, apparatuses, systems related to communication with internet of things (IoT) devices.

### BACKGROUND

In recent years, IoT has attracted much attention in the wireless communication world. More IoT devices are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. Some IoT devices may not be powered by battery that needs to be replaced or recharged manually, which leads to high maintenance cost, serious environmental issues, and even safety hazards for some use cases (e.g., wireless sensor in electric power and petroleum industry).

A radio frequency identification (RFID) procedure is described herein. RFID is usually used currently for applications of asset identification. The inventory procedure from RFID is shown be RFID is usually used currently for applications of asset identification. The inventory procedure from RFID is shown below as mentioned in document entitled “Specification on RF ID Interface-Protocol for Communications at 860 MHz-960 MHz Version 2.0.1 Ratified”.

The FIG. 4 illustrates an example of inventory procedure between an interrogator 401 and a tag 400. In the inventory procedure, the interrogator 401 sends a Select message 402 and a Query message 403 to energize all or a subset of TAGs. Following the Query message 403, the TAG 400 selects a random number from 0-2^{Q-1} and loads its memory with that number. At each reception of a query response, QueryRep, 405, 407; 409, the TAG 400 decrements its counter until the counter reaches 0. When the counter reaches 0 in step 410, the TAG 400 initiates a contention resolution procedure 411 which includes transmitting its device ID in the uplink and waiting for confirmation of the device ID in the downlink (to address possible collision between multiple devices selecting the same random number). For a device 400 that has passed contention resolution, the interrogator 401 can send multiple read/write commands 406, 408, 412 to which the TAG 400 should respond. A query response, QueryRep 413 may be sent by the Interrogator T401 to the Tag 400 after step 412.

### SUMMARY

Methods, architectures, apparatuses, and systems directed to configurations of transmission between a reader and a IoT device are described herein.

Briefly stated, in one embodiment, a wireless transmission reception unit (WTRU) may monitor a first device to reader (D2R) message via a physical channel transmission based on a first one or more configuration parameters. The WTRU may determine a second one or more configuration parameters based on measurements associated with at least one of the physical channel transmission and the first D2R message. The WTRU may transmit a reader to device (R2D) message including information indicating the second one or more configuration parameters. The second one or more configuration parameters are for use for transmission of a subsequent D2R message via a physical channel.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of transmission of a configuration update by a WTRU;

FIG. 3 is a diagram illustrating an example of reception of a configuration update by a reader;

FIG. 4 illustrates a radio frequency identification (RFID) procedure;

FIG. 5 illustrates an ambient internet of things (A-IoT) random access framework.

FIG. 6-9 illustrates different topologies in system including A-IoT;

FIG. 10 illustrates an IoT device;

FIG. 11 illustrates a physical device to reader channel (PDRCH) transmission; and

FIG. 12 illustrates a physical reader device channel (PRDCH) transmission.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

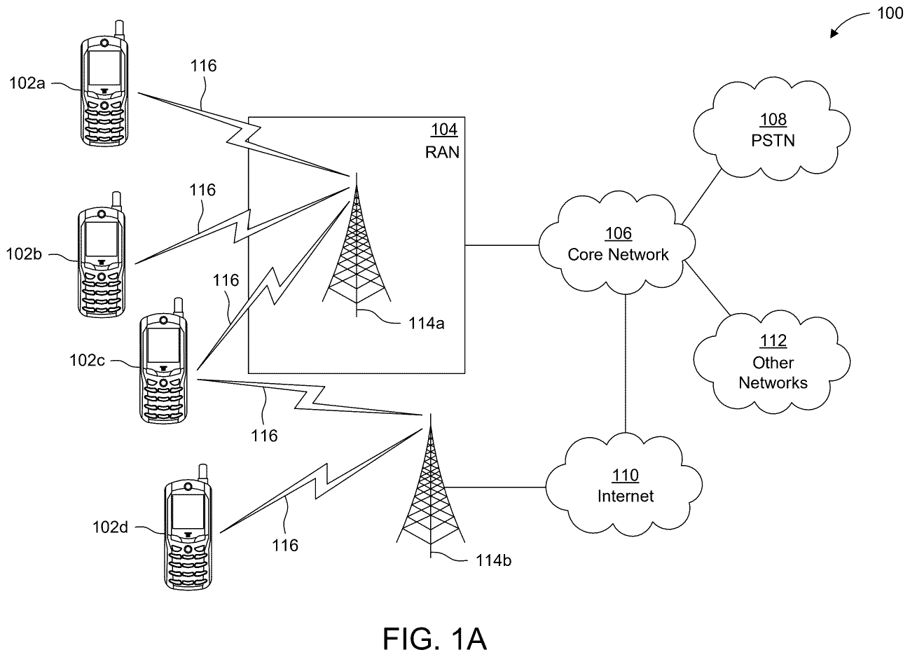

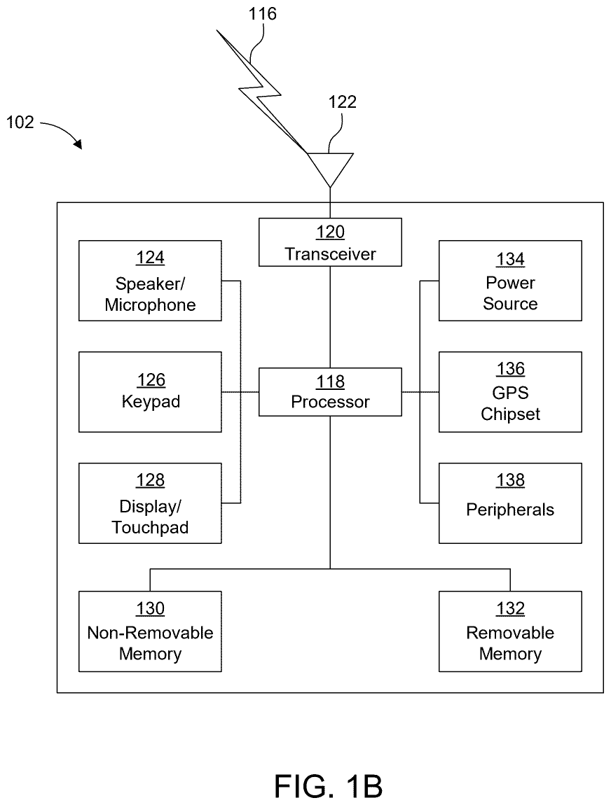

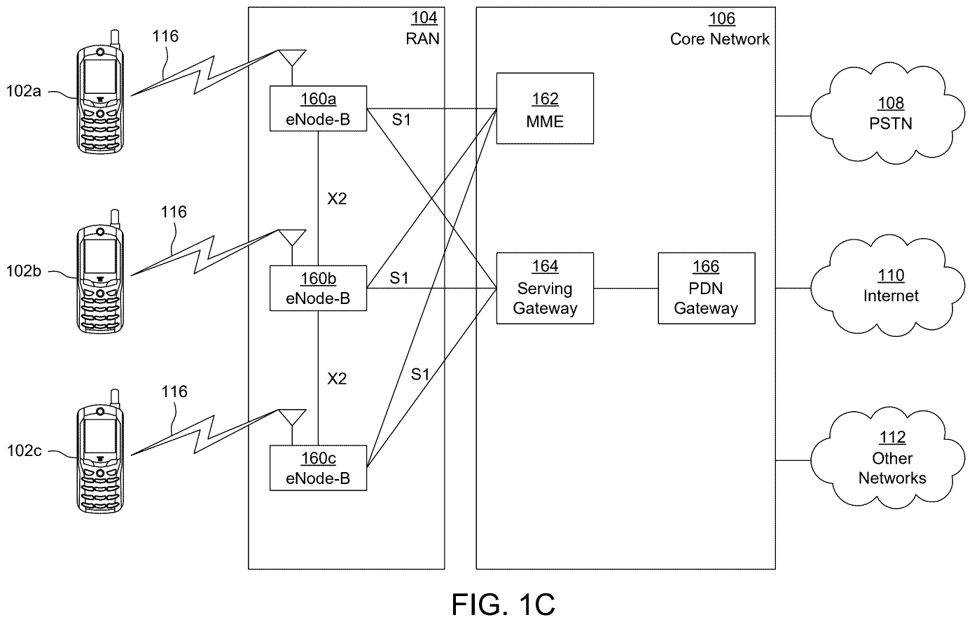

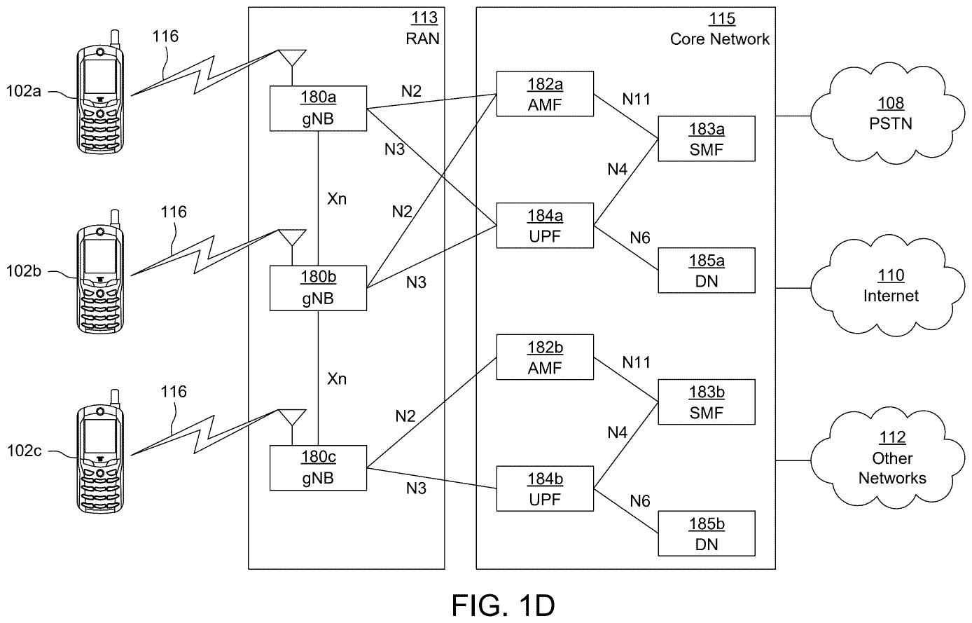

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN. In representative embodiments, the different network elements of networks illustrated in FIGS. 1A-1D may communicate with IoT devices.

The following abbreviations and acronyms may be used throughout the disclosure:
ACK Acknowledgement
A-IoT Ambient IoT
AIoT AF A-IoT application server
AIoTF A-IoT function
AMF Access and Mobility management Function
AS Access-Stratum
BSR Buffer Status Report
BWP Bandwidth Part
CCE Control Channel Element
CE Control Element
CG Configured Grant
CN Core Network
CRC Cyclic Redundancy Check
CQI Channel Quality Indicator and/or Information
CW Contention Window
CWS Contention Window Size
CW Carrier Wave
DCI Downlink Control Information
DG Dynamic grant
DL Downlink
DO-DTT Device Originated Device Terminated Triggered
DRB Data Radio Bearer
DT Device Terminated
D2R Device to Reader
EPC Electronic product code
HARQ Hybrid Automatic Repeat Request
IoT Internet of Things
LMF Location Management Function
LTE Long Term Evolution e.g. from 3GPP LTE R8 and up
NACK Negative ACK
NAS Non-Access-Stratum
NEF Network Exposure Function
NGAP NG Application Protocol
MAC Media Access Control
MAC CE MAC Control Element
MCS Modulation and Coding Scheme
NDI New Data Indicator
NR New Radio
NRF Network Repository Function
OFDM Orthogonal Frequency-Division Multiplexing
PDB Packet Delay Budget
PDU Packet Data Unit
PHY Physical Layer
PO Paging Occasion
PRACH Physical Random Access Channel
PSS Primary Synchronization Signal
QoS Quality of Service
RA Random Access (or procedure)
RACH Random Access Channel
RAR Random Access Response
RCU Radio access network Central Unit
RF Radio Front end
RFID Radio Frequency Identification
RNTI Radio Network Identifier
RO RACH occasion
RRC Radio Resource Control
RSRP Reference Signal Received Power
RSRQ Reference Signal Received Quality
RSSI Received Signal Strength Indicator
R2D Reader to Device
SDU Service Data Unit
SIB System Information Block
SR Scheduling Request
SRB Signaling Radio bearer
SRS Sounding Reference Signal
SS Synchronization Signal
SSB Synchronization Signal Block
SSS Secondary Synchronization Signal
SWG Switching Gap (in a self-contained subframe)
SPS Semi-persistent scheduling
PC Protocol Control
TB Transport Block
TID Tag-identification or Tag identifier
TBS Transport Block Size
UCI User Control Information
UDM Unified Data Management
UDR Unified Data Repository
UPF User Plane Function
UL Uplink
XPC Extended Protocol Control

Ambient IoT (A-IoT) device types are described herein. Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

Third Generation Partnership Project (3GPP) has launched a study item on Ambient-IoT (A-IoT) in 3GPP Rel-19, Release 19. This may be described in a document referred as 3GPP RP-234058 -Study on Solutions for Ambient IoT. As part of the Rel-19 study on A-IoT in 3GPP RAN 1 has identified device types that may be considered for support of A-IoT in 3GPP RAN and uses the following terminologies:

A device type 1 has approximatively a 1 μW peak power consumption, has energy storage, initial sampling frequency offset (SFO) up to 10^{X} ppm, neither downlink (DL) nor uplink (UL amplification in the device. The device's UL transmission is backscattered on a carrier wave provided externally.

A device type 2a has a peak power consumption below a few hundred μW, has energy storage, initial sampling frequency offset (SFO) up to 10^{X} ppm, both DL and/or UL amplification in the device. The device's UL transmission is backscattered on a carrier wave provided externally.

A device type 2b has a peak power consumption below a few hundred μW, has energy storage, initial sampling frequency offset (SFO) up to 10^{X} ppm, both DL and/or UL amplification in the device. The device's UL transmission is generated internally by the device.

These devices each have significantly reduced processing and transmission capabilities, and device of type 1 or type 2a, are incapable of generating signals without energy provided by a carrier wave from the associated reader.

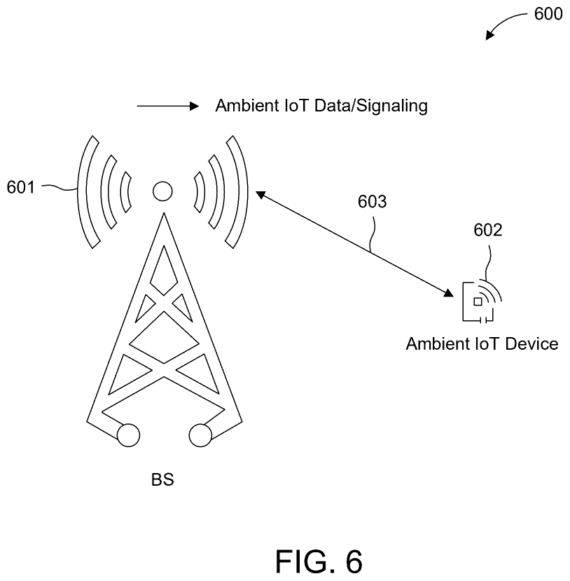

FIGS. 6, 7, 8A, 8B and 9 illustrate different topologies including an A-IoT.

In a topology 1 example shown in FIG. 6, an A-IoT device 602 may directly and bidirectionally communicate with a reader, which is a base station (BS) 602, for both PRDCH and PDRCH, through a wireless bidirectional link 603. The communication between the base station and the A-IoT device may include A-IoT data and/or signaling. According to an embodiment in line with this topology, a BS transmitting to the A-IoT device 602 for PRDCH is different from a BS receiving from the A-IoT device 602 for PDRCH.

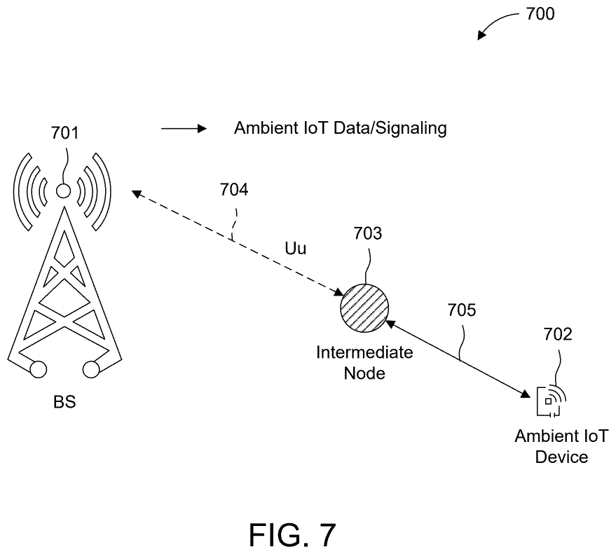

In a topology 2 example shown in FIG. 7, an A-IoT device 702 may communicate bidirectionally through a wireless link 705 with a reader, which is an intermediate node 703 between the device 702 and a base station 701, for both PRDCH and PDRCH. The link 704 between the intermediate node 703 and the BS 701 is a 3GPP link, e.g. a Uu link. In this topology, the intermediate node 703 can be a relay, IAB node, UE, repeater, and more generally a WTRU etc. which is capable of A-IoT. The intermediate node 703 may transfer information between the BS 701 and the A-IoT device 702.

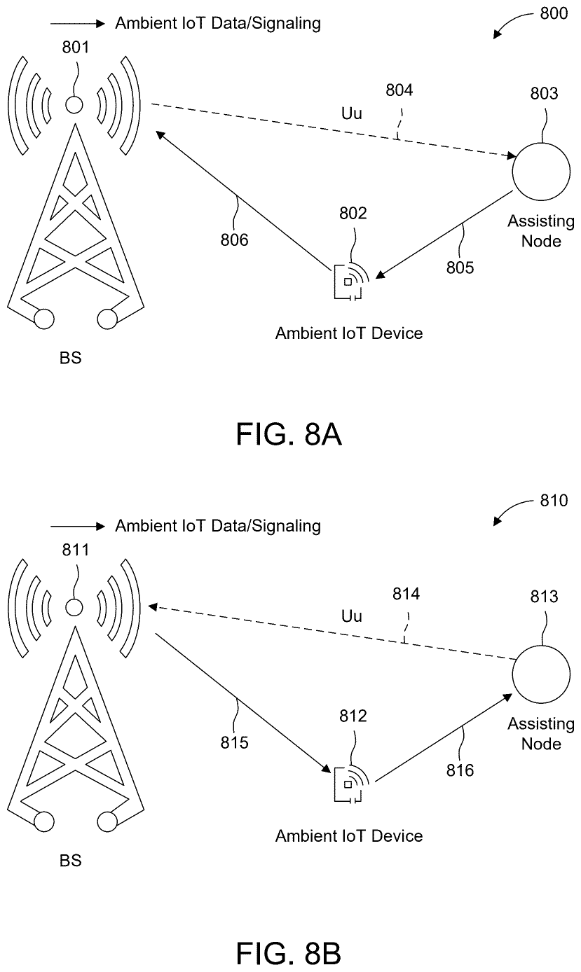

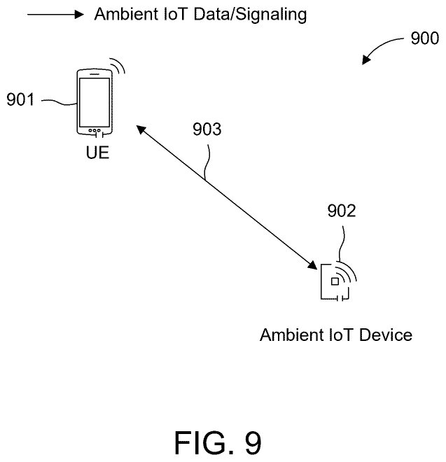

In topology 3 example, FIG. 8A illustrates a downlink assistance, wherein an A-IoT device 802 may transmit data/signaling to a reader; which is a base station 801, for PDRCH through a wireless link 806 and may receive data/signaling from a reader, which is an assisting node 803; for PRDCH. The assisting node 803 may receive data/signaling from the BS 801 through a 3GPP link 804, e.g. a Uu Link. In a topology 3 example, FIG. 8B illustrates an uplink assistance, wherein an A-IoT device 812 may receive data/signaling from reader, which is a base station 811, for PRDCH through a wireless link 815 and may transmit data/signaling to a reader, which is an assisting node 813, for PDRCH through a wireless link 816. The assisting node 813 may transmit data/signaling to the BS 811 through a 3GPP link 804, e.g. a Uu Link. In this topology 3, the assisting nodes 803 or 813 can be a relay, IAB, UE, repeater, and more generally a WTRU etc. which is capable of transmit to data/signaling an A-IoT and/or receive data/signaling from an A-IoT In a topology 4 example shown in FIG. 9, an A-IoT device 902 may communicate bidirectionally with a reader, which may be a UE 901 or WTRU, for both PDRCH and PRDCH, through a bidirectional wireless link 903. The communication between the UE 901 and the A-IoT device 902 may include A-IoT data and/or signaling.

In Rel-19 the use of midamble sequences inserted with PDRCH transmissions is being discussed for the purpose of improving channel estimation for better equalization performance, and for SFO estimation and timing accuracy to mitigate the effect of clock drift on reducing BLER performance for PDRCH transmission. The performance of midambles in both channel estimation and SFO estimation may be dependent on link quality and initial device SFO which is expected to be roughly 10⁴-10⁵ ppm.

Conservative estimates SFO and channel estimation error may result in inefficient spectrum use and device power consumption, as devices will be required to preempt PDRCH data transmission for unnecessary midamble insertion.

Overly optimistic estimates of SFO and channel estimation error may result in unnecessarily high PDRCH failure require retransmissions of PDRCH, or re-initialization of contention-based device access which can increase reader congestion and decrease spectral efficiency in addition to increase device energy consumption.

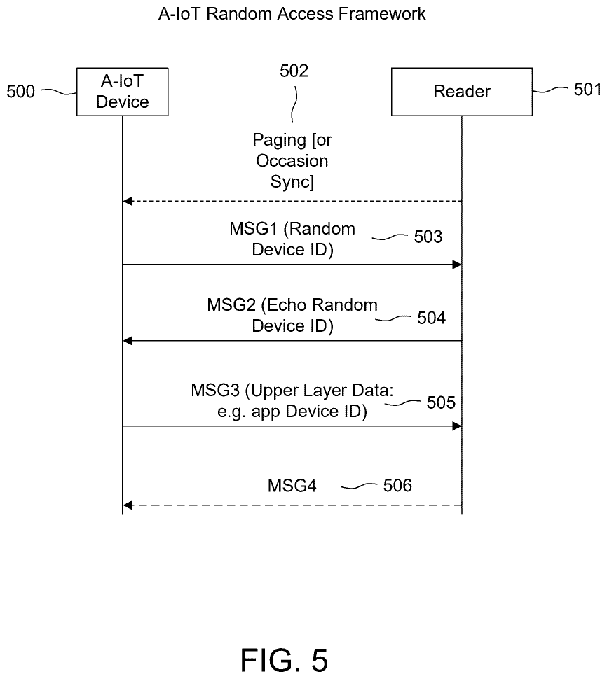

FIG. 5 illustrates an IoT random access framework.

A reader 501 may send a paging message and a set of occasion synchronization messages 502 to IoT devices including an IoT (e.g. an A-IoT) device 500. Occasion synchronization messages may respectively provide device IDs of IoT devices to respond and configure/delimit random-access occasions for transmissions by the IoT devices.

The IoT device 500 may select an occasion (using at least slotted ALOHA as the baseline) and may transmit a random device ID in a message MSG1 503 to the reader 501.

The reader 501, upon successful reception of the MSG1 503, may transmit a message MSG2 504 including the received random device ID.

If the IoT device 500 receives an echoed random device ID in MSG2 504, it may transmit a message MSG3 505 which contains upper layer data (e.g., an application layer device ID) to the reader 501.

A message MSG4 506 may be transmitted by the reader 501 to the IoT device 500 (e.g., for subsequent command transmission or request for more data); contention may already be resolved at MSG2 504 transmission.

For device-to-reader (D2R) preamble design, the functionalities of timing acquisition, SFO estimation/time tracking and channel estimation may be supported.

For D2R midamble design, the functionalities of SFO estimation/time tracking and channel estimation may be supported. D2R midamble can be transmitted at the end of the PDRCH transmission. If it is at the end, it is not designed for being used for indicating the end of PDRCH transmission. Condition(s) and/or indication(s) where the D2R midamble is present or not are considered herein.

In the following, x-amble may refer to a pre-amble or a midamble.

For D2R x-ambles, following may be considered as the types for base sequence and to be further down-selected: option 1 corresponding to M-sequence, or option 2 corresponding to Golay sequence. A preamble or midamble may include other part, e.g. with ON and/or OFF transmission.

For D2R x-ambles, whether and/or what multiple sequences (using same base sequence type) are supported or what multiple sequences are supported are considered herein. There may be a CDMA or no CDMA between D2R x-ambles. Performance at least in terms of autocorrelation/cross-correlation property, SFO estimation/Timing accuracy, Signal to Noise Ratio (SNR) for target PDRCH Block Error Rate (BLER) of [1%, 10%].

In Rel-19 the use of midamble sequences inserted with PDRCH transmissions may be consider for the purpose of improving channel estimation for better equalization performance, and for SFO estimation and timing accuracy to mitigate the effect of clock drift on reducing BLER performance for PDRCH transmission. The performance of midambles in both channel estimation and SFO estimation may be dependent on link quality and initial device SFO which may be expected to be roughly 10\hat{ }4-10\hat{ }5 ppm.

Conservative estimates SFO and channel estimation error may result in inefficient spectrum use and device power consumption, as devices will be required to preempt PDRCH data transmission for unnecessary midamble insertion.

Overly optimistic estimates of SFO and channel estimation error may result in unnecessarily high PDRCH failure require retransmissions of PDRCH, or re-initialization of contention-based device access which can increase reader congestion and decrease spectral efficiency in addition to increase device energy consumption.

In an embodiment, a reader may configure or use a default x-amble insertion rule, e.g., insert a x-amble with duration of L chips after every M chips of PDRCH transmission, and estimate either link quality or SFO estimation variance based on a first PDRCH transmission from a given device. The reader may indicate an update to the default x-amble rule for that device included either in ACK/NACK to the first PDRCH transmission or in a following PRDCH transmission to the same device for later PDRCH transmissions.

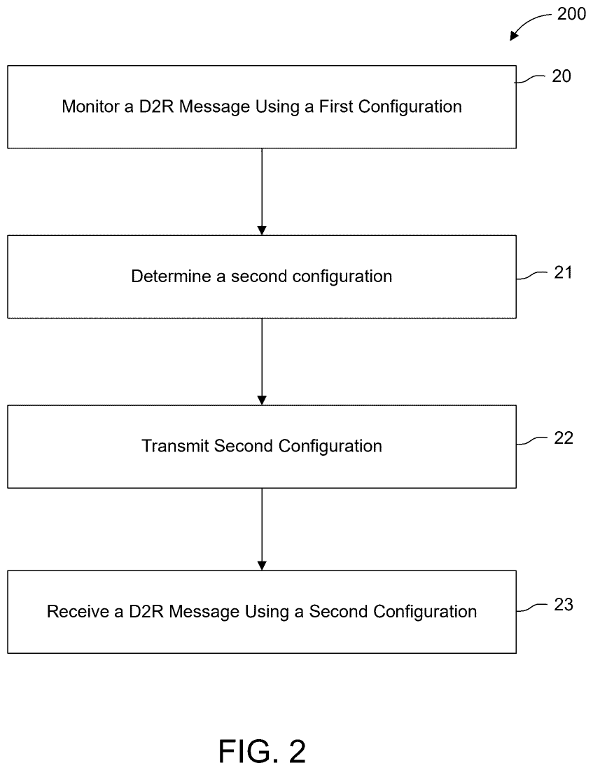

In an embodiment shown in FIG. 2 and illustrating a method 200 implemented in a reader, e.g. a WTRU, the reader may monitor a device to reader (D2R) message sent by an IoT, e.g. an A-IoT device, via a physical channel transmission, based on a first one or more configuration parameters in a step 20. Then, in step 21, the reader may determine a second one or more configuration parameters based on measurements associated with at least one of the physical channel transmission and the first D2R message. Then, in step 22, the reader may transmit to the IoT device a reader to device (R2D) message including information indicating the second one or more configuration parameters. Then, in step 23, the reader may receive a subsequent R2D message using the second one or more configuration parameters, from the IoT, via the physical channel. The D2R message may be a message included in a physical device to reader channel (PDRCH) transmission. A reader to device (R2D) message may be a message included in a physical reader to device channel (PRDCH) transmission. A physical channel transmission may be a PDRCH or PRDCH transmission.

In an embodiment, the a first one or more configuration parameters may correspond to a default configuration or to a configuration including information previously received by the IoT device. In an embodiment, further to reception of the control information, the IoT device may use a configuration in line with the update and transmit a PDRCH message to the reader using this configuration; this may correspond to step 23.

Monitoring a first D2R message includes at least one of:
receiving the first D2R message via the physical channel transmission based on the first one or more configuration parameters;
attempting to receive the first D2R message via the physical channel transmission based on the first one or more configuration parameters; and
receiving from a network element information associated with receiving by the network element the first D2R message via the physical channel transmission based on the first one or more configuration parameters, or attempting to receive by the network element the first D2R message via the physical channel transmission based on the first one or more configuration parameters.

The reader is configured to perform the measurements associated with at least one of the physical channel transmission and the first D2R message, including at least one of:
estimating at least one of a channel, signal to noise ratio, a channel quality, an initial sampling frequency offset (SFO), and initial SFO estimation variance;
checking if the first device to reader (D2R) message is recovered correctly;
determining if channel quality is sufficient (i.e. equal or above a channel quality threshold) for properly performing at least one of equalizing, estimating transmission channel and correcting device SFO; and
determining that initial device SFO is too large (i.e., greater than a SFO threshold) to be properly mitigated using the first one or more configuration parameters.

In an embodiment, the reader is configured to determine the second one or more configuration parameters that would reduce resources used to transmit the subsequent D2R message, if the reader determines at least one of:
the first device to reader (D2R) message is recovered correctly;
a channel quality is sufficient (i.e. equal or above a channel quality threshold) for properly performing at least one of equalizing, estimating transmission channel and correcting device SFO; and
an initial device SFO is not too large (i.e. larger than a threshold) to be properly mitigated, using the first one or more configurations parameters.

In an embodiment, the reader is configured to determine the second one or more configuration parameters that would increase resource used to transmit the subsequent D2R message, if the reader determines at least one of:
the first device to reader (D2R) message is not recovered correctly;
a channel quality is not sufficient (i.e. below a channel quality threshold) for properly performing at least one of equalizing, estimating transmission channel and correcting device SFO; and
an initial device SFO is too large (i.e. greater than a SFO threshold) to be properly mitigated, using the first one or more configurations parameters.

In an embodiment, the first one of more configuration parameters are used for pre-amble or mid-amble in a transmission of the first D2R message and wherein the second one of more configuration parameters are used for pre-amble or mid-amble in a transmission of the subsequent D2R transmission.

According to different embodiments, the reader is one or any of a gNodeB, a user equipment (UE) and a repeater.

In an embodiment, information indicating the second one or more configuration parameters includes a validity window during which the second one or more configuration parameters are valid. This validity window may correspond to maximum time period corresponding to an absolute time or a relative time (e.g. with regards to a D2R transmission) and/or to a maximum number of D2R transmissions or attempts. After the expiration of the validity window, the IoT device is configured to send to the IoT and the reader is configured to receive from the IoT device, a second subsequent D2R message using the first one or more configuration parameters, that may be default configuration parameters. In an embodiment, the reader may also transmit a third one or more configuration parameters to the device replacing the one or more second configuration parameters during the validity window or after the validity window.

In an embodiment, the first one or more configuration parameters are for use for transmission of a subsequent D2R message via the physical channel associated with at least a first type of D2R messages and the second one or more configuration parameters are for use for transmission of a subsequent D2R message via the physical channel a second configuration is associated with at least a second type of D2R messages.

In an embodiment, information of a first type of D2R message is included in the information indicating an information of a first type of D2R message is included in the information indicating a second one or more configuration parameters or is a predefined type of D2R message.

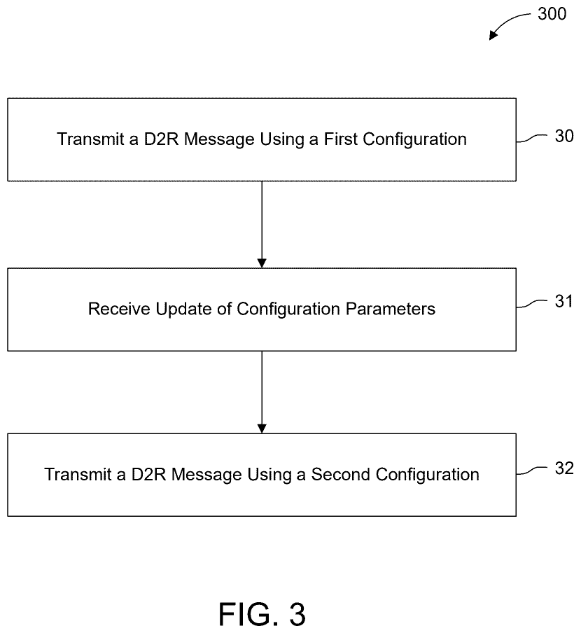

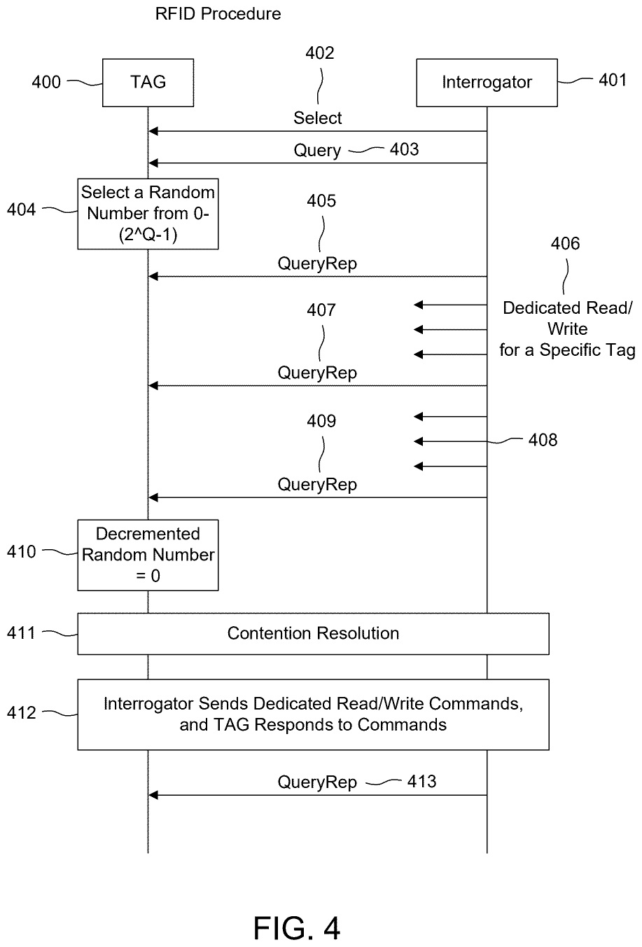

In an embodiment shown in FIG. 3 and illustrating a method 300 implemented in an IoT device, e.g. an A-IoT, the IoT device may transmit a PDRCH message to a reader, e.g. a WTRU, using a first configuration in a step 30. Then, in step, 31, the IoT device may receive from the reader control information, including an update of one or more configuration parameters to be used for Physical Device to Reader Channel (PDRCH) transmission from the IoT device to the reader. Then, in step 32, the IoT device may transmit a PDRCH message from the IoT using a second configuration.

In an embodiment, the reader may indicate an x-amble configuration rule to the IoT device to use for PDRCH transmission made as part of an indicated service ID; the configuration may include a sequence type, e.g. Golay, m-sequence, clock sequence, a sequence length, e.g. L chips OR short/long, and/or a Sequence frequency, e.g. insert sequence after every M chips of PDRCH transmission. Then, the reader may initiate service operation associated with a given service ID. Then, the reader may receive a first PDRCH from the IoT device as part of this service operation, e.g. a message Msg1 with a given device ID based on the configuration rule provided indicated by the reader. The reader may estimate channel, channel quality (e.g., CQI, RSRP, RSRQ), initial SFO, and/or initial SFO estimation variance. The reader may check if PDRCH transmission is recovered correctly. Reader determines if channel quality is sufficient (i.e. equal or above a channel quality threshold) for properly equalizing and/or estimating and correcting device SFO. Then, the reader may transmit control information to the IoT device as illustrated in FIG. 2. The reader may transmit control information to the IoT device in an ACK or NACK indicating a success or failure of the PDRCH transmission, or in another kind of PRDCH. The control information including an update of at least one, some or all of the configuration parameters may be included in a PRDCH transmitted by the reader to the IoT device, for example, in preamble, data part or midamble.

In this disclosure, the terms device, IoT, A-IoT, UE, TAG may be used interchangeably to mean the IoT device that is being inventoried/queried by a reader.

The term reader may refer to an entity which queries an IoT device, either directly, or via an intermediate UE in topology 2. The term reader in topology 2 may also refer to the intermediate UE. As a result, the term reader may refer to a network node or a UE, depending on the context and/or the topology.

In this disclosure, we may use the terms reader, network, intermediate UE, interchangeably to mean the reader. This results in a tradeoff between number of resources for random access, the size of the random ID (i.e., the number of unique IDs that can be selected), and the power consumption associated with the devices. Specifically, a large number of resources is not preferrable because it increases the time required for the inventory procedure. The time can be shortened using less resources and increasing the size of the random ID. However, this will result in increased power consumption. If the same size of the random ID is used in all cases, the system may consume device power unnecessarily.

In this disclosure, inventory may refer to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID or perform a RACH procedure. Specifically, the inventory procedure refers to a set of access occasions which may have 0 or at least 1 device respond within the access occasion. Inventory procedure may occur similar to legacy RFID procedure. Although referred to herein as inventory procedure, it may be termed differently in device requirements or specifications (e.g., query procedure, paging procedure, etc.).

In this disclosure, occasion may refer to the opportunity for device transmission that may be delimited by the transmission of a query rep message (or similar). Specifically, a device may perform transmission in an occasion by performing a IoT transmission in a defined time following the query rep associated with that transmission. Alternatively, an occasion may include both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

Herein, depending on the solution or description, any reference to time can be associated with an absolute time measurement (e.g., seconds, slots, frames, etc.). Alternatively, it can refer to a number of executions of a procedure, possibly triggered by a reader (e.g., number of inventory procedures, number of accesses or RACH procedures, etc.). Alternatively, it can refer to a number of messages, possibly of a specific type, or containing specific information, as described herein, received or transmitted.

Configuration or pre-configuration may refer to any configuration received by a message (e.g., an RRC message, a MAC CE, a PHY layer signal, a data PDU, a control PDU associated with any or a new protocol layer, etc.) received from either a network node, or from another device or UE. A device herein may be configured by a reader, whereby the reader may be a network node or a UE (e.g., intermediate UE in topology 2). In the case of a UE, the UE may derive the device configuration itself, or receive the device configuration from the network, in which case, the device configuration is being relayed from the network to the device by the UE. On the other hand, a UE configuration (in the case of a UE in topology 2) may be received from a network node (e.g., the gNB).

In this disclosure, the term resource (when referring to the IoT interface) can refer to at least any of the following:
A time/frequency resource in the traditional sense;
A frequency resource which may be available at different times; and
A time resource (possibly limited to one or more frequencies or frequency ranges) which starts from the transmission of a reader message, and which lasts either a maximum time period, or until the next transmission by the reader, possibly of a specific message.

Different components of embodiments are described herein.

In particular, an initial device x-amble configuration is described herein.

A reader may provide a device with an initial x-amble configuration. This may include a separate configuration rule for the device preamble and the device midamble. Some or all of the configuration parameters for preamble and midamble may be shared.

The initial configuration may for a preamble may include preamble format information including one or more of:
a sequence type: e.g., a Golay sequence, m-sequence, clock sequences;
sequence combinations: e.g., clock sequences followed by a Golay sequence, etc.;
a sequence length;
a sequence power relative to PDRCH transmission;
whether a short or long variant of the sequence is used, e.g., 32-bit sequence or a 64-bit sequence, etc.; and
a number of repetitions of the sequence included in the preamble.

The initial configuration for a midamble may include midamble format information including one or more of:
a sequence type: e.g., a Golay sequence, m-sequence, clock sequences;
sequence combinations: e.g., clock sequences followed by Golay sequence, etc.;
a sequence length;
a sequence power relative to PDRCH transmission;
whether a short or long variant of the sequence is used, e.g., 32-bit sequence or a 64-bit sequence, etc.;
a midamble periodicity: e.g. indication to insert a midamble after every M chips of PDRCH transmission;
a midamble distance to preamble;
a number of repetitions of the sequence included in the midamble; and
a minimum transport block size for midamble insertion: e.g. TBS must be >Y bits, etc.

The initial x-amble configuration may be specified with a fixed format, or the x-amble configuration may be configured for each device during an initial discovery period, or the x-amble configuration may be indicated explicitly for a given service operation (e.g., inventory or command) by the reader in a PRDCH that triggers the service operation.

The x-amble configuration indication method may be assumed to be different for different service operations. As an example, a reader may implicitly indicate a fixed x-amble configuration for inventory procedures, but always explicitly provide an x-amble configuration for read/write commands.

The initial midamble configuration may include a hybrid configuration of multiple midamble format. As an example, X out of N midambles inserting may use one format, while the remaining N-X midambles inserted use a different format.

A reception of PDRCH with initial x-amble configuration is described herein.

A reader may receive a PDRCH transmission from a device with x-amble configuration rules indicated for the first x-amble configuration. This PDRCH may be a message Msg1 during a random-access procedure for contention-based access as in an inventory procedure. This PDRCH may be a contention free transmission for a device that received an explicit indication to complete e.g. a read command.

The reader may attempt to decode the PDRCH transmission assuming the device included preambles and midambles according to the first x-amble configuration. The reader may determine if the PDRCH transmission was received correctly by using an e.g. CRC.

Alternatively, reader may determine the x-amble configuration rule used by the device as indicated in D2R control signaling indicated by the device in the transmitted PDRCH.

The reader may estimate the achievable mitigation of channel distortion and/or sampling frequency offset (SFO) between the reader and the device by measuring the transmitted preamble and/or midamble(s). This estimate may include any of:
estimation of initial device SFO;
estimation of transmission SNR and/or SINR; and
determination of whether PDRCH was correctly received via CRC check.

The reader may determine that the initial x-amble configuration was insufficient for recovering the PDRCH (i.e. the initial x-amble configuration does not enable a proper PDRCH recovery or decoding). This determination may include estimating that the initial device SFO was too large (i.e. equal or greater a SFO threshold) to properly mitigate, or determining the estimated SNR was too low (i.e. below of SNR threshold) to properly estimate the channel or determining that the PDRCH transmission did not pass its CRC check. In the case of low SNR, the estimate the of wireless channel used to equalize the data, may be noisy producing an estimate with a high degree of error. This may degrade the decoding performance of the receiver in estimating what bits are sent. This could be improved either by using a longer sequence or a higher power transmission which are two of the listed parameters. In the case of high SFO, there may be a same problem from low SNR, which results in a noisy estimate of SFO. There may also be a limitation in how accurate the SFO estimate is based on how long the sequence is. This may be because SFO would be estimated by measuring the phase error accrued over each sample of the mid-amble. In either case, an inaccurate SFO estimate may mean that the reader and the device will drift out of synchronization as more data is transmitted. The higher the SFO, the faster this drift may start producing decoding errors. This could be mitigated by increasing the length/power of the mid-amble to improve SFO estimate, or by spacing the mid-ambles more closely so that the reader and device can correct more frequently before drifting out of synch.

The reader may determine that the initial x-amble configuration was over-provisioned for recovering the PDRCH. This determination may include estimating that the initial midamble configuration used more resources than needed to mitigate the initial device SFO, or the preamble used too many resources to estimate the channel given the SNR.

An indication of updated x-amble (pre-amble or mid-amble) is described herein.

The reader may determine an optimal x-amble configuration for successive transmissions made by the device. In the case where the reader determined that the x-amble configuration was estimated to be insufficient (or adapted to enable a proper reception or decoding of PDRCH or a quality measurement being below a quality threshold) this determination may include modifying the preamble configuration to improve channel estimation quality at lower SNR or modifying midamble insertion rules to mitigate larger initial device SFO. In the case where the reader determines that the x-amble configuration was estimated to be over-provisioned the reader may reduce the resources for midamble insertion to better match the high SNR, or the low initial device SFO. In general, the IoT devices are very simple, and dependent entirely on the reader to tell them how to behave. There may be cases where an IoT device would do better by ignoring the configuration update, e.g. the device has a limited amount of energy available and will not be able to complete the transmission with the new configuration.

Updates to preamble configuration rule may include:
Selecting a different sequence type (e.g. encoded as one or two bits for different types):
e.g., a Golay sequence, an m-sequence, clock sequences;
Adding/removing sequence combinations (e.g. encoded as one bit, e.g. as 1 corresponding to a sequence and 1 corresponding to clock+sequence): e.g., clock sequences followed by a Golay sequence, etc.;
Increasing or decreasing a sequence length (encoded as a number of bits to cover a range of increases in chip duration or decreases in chip duration);
Increasing or decreasing a sequence power relative to PDRCH transmission;
Selecting a different variant of a sequence is used, e.g., changing from a short format of the preamble to a long format or vice versa;
Increasing or decreasing the number of repetitions of the sequence included in the preamble (encoded as a number of bits to cover a range).

For pre-amble, the main parameters used in update of configuration may be the length (which may enable a flexible increase or decrease, a change between short and long format, or increase or decrease in repetitions) and power.

Updates to mid-amble configuration may include:
Selecting a different sequence type e.g. encoded as one or two bits for different types):
e.g., Golay sequence, m-sequence, clock sequences;
Adding/removing sequence combinations (e.g. encoded as one bit, e.g. as 1 corresponding to a sequence and 1 corresponding to clock+sequence): e.g., clock sequences followed by a Golay sequence, etc.;
Increasing or decreasing a sequence length (encoded as a number of bits to cover a range of increases in chip duration or decreases in chip duration);
Increasing or decreasing a sequence power relative to PDRCH transmission;
Selecting a different variant of the sequence is used, e.g., changing from a short format of the preamble to a long format or vice versa;
Increasing or decreasing a number of repetitions of the sequence included in the preamble;
Increasing or decreasing a mid-amble periodicity (encoded as a number of bits to cover a range of mid-amble periodicity): e.g. increase or decrease the number of PDRCH chips between each mid-amble insertion;
Increasing or decreasing a number of chips between the first mid-amble and the preamble (encoded as a number of bits to cover a range of number of chips);
Increasing or decreasing a number of repetitions of the sequence included in the mid-amble (encoded as a number of bits to cover a range of number of repetitions);
In the case where a hybrid midamble configuration is used each of the midamble configurations may be modified individually or all midamble configuration may be modified jointly.

An explicit indication of updated x-amble (preamble or mid-amble) is described herein.

An updated x-amble configuration may be explicitly indicated by a reader to a device in the next PRDCH transmission to the device scheduling a successive PDRCH transmission. This indication may be provided differentially based on the initial x-amble configuration. As an example, a reader may indicate that the device should increase the length of its preamble configuration by X bits relative to its initial configuration.

An implicit indication of updated x-amble configuration rules (preamble or mid-amble) is described herein.

An updated x-amble configuration may be indicated implicitly to device. As one example, in cases where a reader indicates X consecutive NACKs to a PDRCH transmission from the same device indicating PDRCH failure the reader may expect the device to increase, e.g., the length of the preamble and/or midamble, or decrease the number of PDRCH chips between midamble insertion. Alternatively, if a reader indicates Y consecutive successful PDRCH transmissions by e.g., ACK or NDI indication, the reader may expect the device to e.g., decrease the duration of its preamble or midamble or increase the number PDRCH chips between midamble insertions.

Implicit updates to x-amble configuration rules may also be associated with other D2R or R2D control signaling. As one example, a reader may indicate an explicit x-amble update but only expect that the device will apply the updated rule for specific service type identifiers (e.g., read commands, etc.). In another example, a reader may indicate an explicit x-amble update but only expect that the device will apply the updated rule if the device has available energy or is capable of completing its next PDRCH transmission as configured. In another example, a reader may expect a device to use the indicated x-amble configuration update if the device is retransmitting is previous message, but a different updated x-amble configuration or the initial x-amble configuration if the device is expected to e.g., repeat the service command from the beginning.

Expiration of indicated x-amble updates is described herein.

A reader may assume that an updated x-amble configuration indicated to a device for successive PDRCH transmissions may be valid only for a limited number of PDRCH transmissions after the indication is sent. This limited number of PDRCH transmissions may indicated explicitly to device along with the updated x-amble configuration. Alternatively, the device may be expected to configure a timer (e.g., X ms, or Y successive PRDCH transmissions) after successful reception of an x-amble configuration update. After the timer expires the reader may expect the device to continue using the initial x-amble configuration. Alternatively, the reader may expect the timer may be reset by providing a new x-amble configuration update to the device. Validity window may be a clock value. It may be in the form of count X milliseconds after receiving this configuration or after the first time applying it. IoT devices may also have poor clocks so a validity window may be in terms of number of PRDCHs received after this first reception, or number of PDRCHs transmitted after first transmission with new configuration. A validity window may also be counted using the service ID provided by the reader.

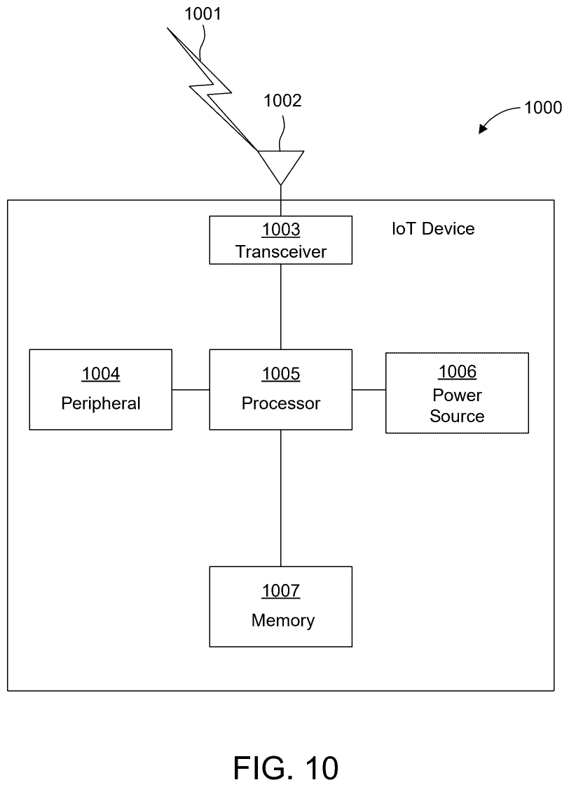

FIG. 10 is a system diagram illustrating an example an IoT device 1000. As shown in FIG. 10, the IoT device 1000 may include a processor 1005, a transceiver 1003, a transmit/receive element 1002, peripherals 1004, a memory 1007 (non-removable memory and or removable memory), a power source 1006, and/or other elements/peripherals among others. It will be appreciated that the IoT device 1000 may include any sub-combination of the foregoing elements while remaining consistent with an embodiment.

The processor 1002 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the IoT device 1000 to operate in a wireless environment. The processor 1005 may be coupled to the transceiver 1003, which may be coupled to the transmit/receive element 1002. While FIG. 10 depicts the processor 1005 and the transceiver 1003 as separate components, it will be appreciated that the processor 1005 and the transceiver 1003 may be integrated together, e.g., in an electronic package or chip.

The transmit/receive element 1002 may be configured to transmit signals to, or receive signals from, a reader over the air interface 1001. For example, in an embodiment, the transmit/receive element 1002 may be an antenna configured to transmit and/or receive RF signals. In an embodiment, the transmit/receive element 1002 may be an emitter/detector configured to transmit and/or receive IR, UV, or visible light signals, for example. In an embodiment, the transmit/receive element 1002 may be configured to transmit and/or receive both RF and light signals. It will be appreciated that the transmit/receive element 1002 may be configured to transmit and/or receive any combination of wireless signals.

Although the transmit/receive element 1002 is depicted in FIG. 10 as a single element, the IoT device 1000 may include any number of transmit/receive elements 1002. For example, the IoT device 1000 may employ MIMO technology. Thus, in an embodiment, the IoT device 1000 may include two or more transmit/receive elements 1002 (e.g., multiple antennas) for transmitting and receiving wireless signals over the air interface 1001.

The transceiver 1003 may be configured to modulate the signals that are to be transmitted by the transmit/receive element 1002 and to demodulate the signals that are received by the transmit/receive element 1002. As noted above, the IoT device 1000 may have multi-mode capabilities. Thus, the transceiver 1003 may include multiple transceivers for enabling the IoT device 1000 to communicate via multiple RATs, such as NR and IEEE 802.11, for example.

The processor 1005 of the IoT Device 1002 may be coupled to, and may receive user input data from, a speaker/microphone a keypad, and/or a display/touchpad (e.g., a liquid crystal display (LCD) display unit or organic light-emitting diode (OLED) display unit). The processor 1005 may also output user data to a speaker/microphone, a keypad, and/or the display/touchpad. In addition, the processor 1005 may access information from, and store data in, any type of suitable memory 1007, such as the non-removable memory and/or the removable memory. The memory 1007 may include random-access memory (RAM), read-only memory (ROM), a hard disk, or any other type of memory storage device. The memory 1007 may include a subscriber identity module (SIM) card, a memory stick, a secure digital (SD) memory card, and the like. In other embodiments, the processor 1005 may access information from, and store data in, memory that is not physically located on the IoT device 1000, such as on a server or a home computer (not shown).

The processor 1005 may receive power from the power source 1006, and may be configured to distribute and/or control the power to the other components in the IoT device 1000. The power source 1006 may be any suitable device for powering the IoT device 1000. For example, the power source 1006 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. I may also include energy harvesting.

The processor 1005 may also be coupled to a GPS chipset 136, which may be configured to provide location information (e.g., longitude and latitude) regarding the current location of the IoT device 1000. In addition to, or in lieu of, the information from a GPS chipset, the IoT device 1000 may receive location information over the air interface 1001 from a base station (e.g., base stations 114a, 114b) and/or determine its location based on the timing of the signals being received from two or more nearby base stations and/or a reader. It will be appreciated that the IoT device 1000 may acquire location information by way of any suitable location-determination method while remaining consistent with an embodiment.

The processor 1005 may further be coupled to other elements/peripherals 1004, which may include one or more software and/or hardware modules/units that provide additional features, functionality and/or wired or wireless connectivity. For example, the elements/peripherals may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 1004 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The IoT device 1000 may include a full duplex radio for which transmission and reception of some or all of the signals (e.g., associated with particular subframes or transmissions for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 1005). In an embodiment, the IoT device 1000 may include a half-duplex radio for which transmission and reception of some or all of the signals (e.g., associated with particular subframes or transmissions for either the uplink (e.g., for transmission) or the downlink (e.g., for reception)).

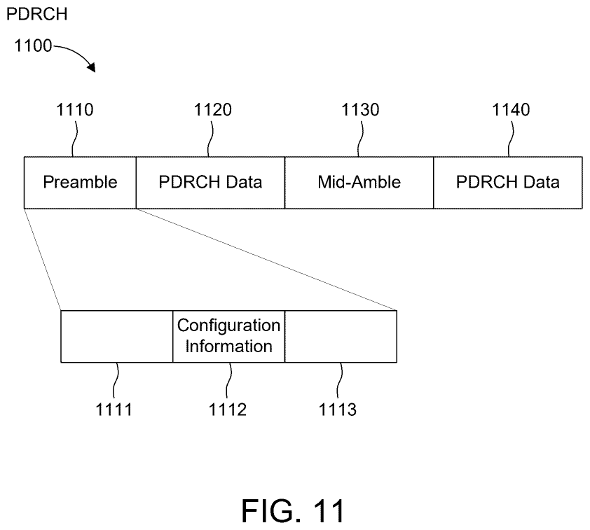

FIG. 11 illustrates a Physical Device to Reader Channel (PDRCH) 1100. The PRDCH 1100 includes a preamble 1110, first PDRCH Data 1120, a mid-amble 1130 and second PDRCH data 1140.

The preamble 1110 includes different fields 1111 to 1113, including configuration information 1112, that may include one or more configuration parameters used for transmission of a subsequent D2R message via the physical channel, or acknowledge or non-acknowledge of configuration parameters.

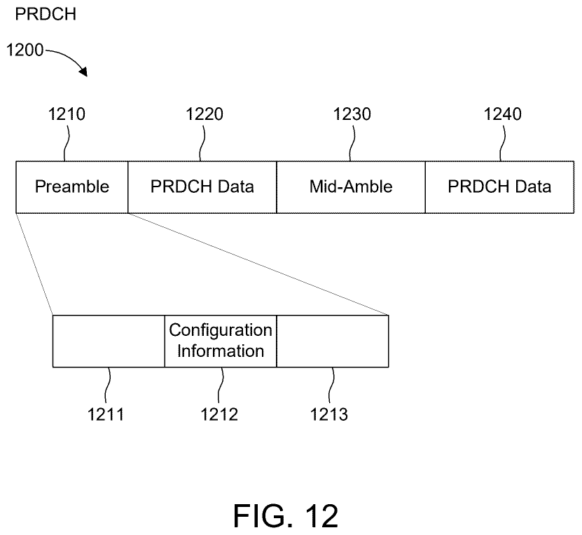

FIG. 12 illustrates a Physical Reader Device Channel (PRDCH) transmission. The PRDCH 1200 includes a preamble 1210, first PRDCH Data 1220, a mid-amble 1230 and second PRDCH data 1240.

The preamble 1210 includes different fields 1211 to 1213, including configuration information 1212, that may include one or more configuration parameters are for use for transmission of a subsequent D2R message via the physical channel, and/or a validity window.

The PRDCH may be a unicast transmission to transmit configuration information to a specific IoT device. Some parameters, e.g. SNR and SFO, may be dedicated to a specific IoT device. Some parameters may also be dedicated to several devices or all devices associated with a reader. The reader may also transmit configuration information to several devices via a multi-cast R2D transmission or a broadcast R2D transmission. This may lead to less overhead.

In an embodiment, the mid-amble 1230 includes configuration information 1212. In an embodiment configuration information data are included in both preamble 1210 and mid-amble 1230 or only in preamble 1210 or only in mid-amble 1230. A PRDCH may include a single mid-amble 1230 or several mid-ambles. In case the PRDCH include several mid-ambles, one or mor mid-amble may include configuration information data.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.” One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A wireless transmission reception unit (WTRU) comprising circuitry, including a transmitter, a receiver, a processor, and memory, and configured to:
monitor a first device to reader (D2R) message via a physical channel transmission based on a first one or more configuration parameters;
determine a second one or more configuration parameters based on measurements associated with at least one of the physical channel transmission and the first D2R message; and
transmit a reader to device (R2D) message including information indicating the second one or more configuration parameters,
wherein the second one or more configuration parameters are for use for transmission of a subsequent D2R message via a physical channel.

2. The WTRU of claim 1, wherein monitoring a first D2R message includes at least one of:
receiving the first D2R message via the physical channel transmission based on the first one or more configuration parameters;
attempting to receive the first D2R message via the physical channel transmission based on the first one or more configuration parameters; and
receiving from a network element information associated with receiving by the network element the first D2R message via the physical channel transmission based on the first one or more configuration parameters, or attempting to receive by the network element the first D2R message via the physical channel transmission based on the first one or more configuration parameters.

3. The WTRU of claim 1, wherein the WTRU is configured to perform the measurements associated with at least one of the physical channel transmission and the first D2R message, including at least one of:
estimating at least one of a channel, signal to noise ratio, a channel quality, an initial sampling frequency offset (SFO), and initial SFO estimation variance;
checking if the first device to reader (D2R) message is recovered correctly;
determining if channel quality is sufficient for properly performing at least one of equalizing, estimating transmission channel and correcting device SFO; and
determining that initial device SFO is too large to be properly mitigated using the first one or more configuration parameters.

4. The WTRU of claim 3, wherein the WTRU is configured to determine the second one or more configuration parameters that would reduce resources used to transmit the subsequent D2R message, if the WTRU determines at least one of:
the first device to reader (D2R) message is recovered correctly;
a channel quality is sufficient for properly performing at least one of equalizing, estimating transmission channel and correcting device SFO, and an initial device SFO is not too large to be properly mitigated, using the first one or more configurations parameters.

5. The WTRU of claim 3, wherein the WTRU is configured to determine the second one or more configuration parameters that would increase resource used to transmit the subsequent D2R message, if the WTRU determines at least one of:
the first device to reader (D2R) message is not recovered correctly;
a channel quality is not sufficient for properly performing at least one of equalizing, estimating transmission channel and correcting device SFO; and
an initial device SFO is too large to be properly mitigated, using the first one or more configurations parameters.

6. The WTRU of claim 1, wherein the WTRU is configured to receive the subsequent D2R message via the physical channel, wherein the second one or more configuration parameters are used.

7. The WTRU of claim 1, wherein the physical channel is a physical device to reader channel (PDRCH).

8. The WTRU of claim 1, wherein the first one of more configuration parameters are used for pre-amble or mid-amble in a transmission of the first D2R message, and wherein the second one of more configuration parameters are used for pre-amble or mid-amble in a transmission of the subsequent D2R transmission.

9. The WTRU of claim 1, wherein the WTRU is one or any of a gNodeB, a user equipment (UE) and a repeater.

10. The WTRU of claim 1, wherein information indicating the second one or more configuration parameters includes a validity window during which the second one or more configuration parameters are valid.

11. The WTRU of claim 10, wherein the validity window is associated with a maximum time period or a maximum number of D2R transmissions.

12. The WTRU of claim 10, wherein the WTRU is configured to:
after expiration of the validity window, receive from the device, a second subsequent D2R message using the first one or more configuration parameters.

13. The WTRU of claim 1, wherein the first one or more configuration parameters are for use for transmission of a subsequent D2R message via the physical channel associated with at least a first type of D2R messages, wherein the second one or more configuration parameters are for use for transmission of a subsequent D2R message via the physical channel, and wherein a second configuration is associated with at least a second type of D2R messages.

14. The WTRU of claim 13, wherein information of a first type of D2R message is included in the information indicating a second one or more configuration parameters or is a predefined type of D2R message.

15. The WTRU of claim 14, wherein the device is an internet of things (IoT) device.

16. A method implemented in a wireless transmission reception unit (WTRU), the method comprising:
monitoring a first device to reader (D2R) message via a physical channel transmission based on a first one or more configuration parameters;
determining a second one or more configuration parameters based on measurements associated with at least one of the physical channel transmission and the D2R message; and
transmitting a reader to device (R2D) message including information indicating the second one or more configuration parameters,
wherein the second one or more configuration parameters are for use for transmission of a subsequent D2R message via a physical channel.

17. The method of claim 16, wherein monitoring a first D2R message includes at least one of:
receiving the first D2R message via the physical channel transmission based on the first one or more configuration parameters;
attempting to receive the first D2R message via the physical channel transmission based on the first one or more configuration parameters; and
receiving from a network element information associated with receiving by the network element the first D2R message via the physical channel transmission based on the first one or more configuration parameters, or attempting to receive by the network element the first D2R message via the physical channel transmission based on the first one or more configuration parameters.

18. The method of claim 16, or comprising performing the measurements associated with at least one of the physical channel transmission and the first D2R message, including at least one of:
estimating at least one of a channel, signal to noise ratio, a channel quality, an initial sampling frequency offset (SFO), and initial SFO estimation variance;
checking if the first device to reader (D2R) message is recovered correctly;
determining if channel quality is sufficient for properly performing at least one of equalizing, estimating transmission channel and correcting device SFO; and
determining that initial device SFO is too large to be properly mitigated using the first one or more configuration parameters.

19-20. (canceled)

21. The method of claim 16, comprising receiving the subsequent D2R message via the physical channel, wherein the second one or more configuration parameters are used.

22-30. (canceled)

31. An internet of things (IoT) device comprising circuitry, including a transmitter, a receiver, a processor, and memory, and configured to:
transmitting a first device to reader (D2R) message via a physical channel transmission based on a first one or more configuration parameters to a reader; and
receiving a reader to device (R2D) message including information indicating a second one or more configuration parameters,
wherein the second one or more configuration parameters are for use for transmission of a subsequent D2R message via a physical channel.

32-50. (canceled)
